(19) United States
(12) Patent Application Publication
(10) Pub. No.: US 2006/0159241 A1
(43) Pub. Date: Jul. 20, 2006

(54) System and method for providing an interactive voice recognition system

(75) Inventors: Vallabha Josyula Jagdish, San Ramon, CA (US); Christopher Charles Baker, Livermore, CA (US); Cuong Duc Le, Schaumburg, IL (US); Eileen E. Burke, Saint Louis, MO (US); Lina Rijanto, Danville, CA (US); Siyu Liu, Danville, CA (US); Jack LeRoy Sutton JR., Madison, CT (US); Jagruti Chimanlal Sheth, Fenton, MO (US); Marcialito V. Nuestro, Livermore, CA (US); Jayant Thomas, San Ramon, CA (US); David J. Silva, Gilberts, IL (US); Katherine L. Nealon, Pittsburg, CA (US); Wayne G. Wisniewski, Downers Grove, IL (US); Shashi K. Pandey, Hanover Park, IL (US); Jason M. Mueller, St. Louis, MO (US); Jiayu Sun, Ballwin, MO (US)

Correspondence Address: PAUL S MADAN;MADAN, MOSSMAN & SRIRAM, PC, 2603 AUGUSTA, SUITE 700, HOUSTON, TX, 77057-1130, US

(73) Assignee: SBC Knowledge Ventures L.P., Reno, NV (US)

(21) Appl. No.: 11/038,911

(22) Filed: Jan. 20, 2005

(51) Int. Cl. H04M 11/00

(52) U.S. Cl. 379/88.16

(57) ABSTRACT

A framework is described for providing a service to a customer via a Interactive Voice Recognition system (IVR) using natural language expressions. The expressions are evaluated using rules-based programming rules. Evaluated expressions determine an eligibility of a business service to be offered to a customer. Interaction with the customer comprises selecting a semantically correct natural language expression from an appropriate vocabulary database.

### BACKGROUND OF THE INVENTION

1. Field of the Invention

The present invention relates to a system and method for of providing an Interactive Voice Recognition system (IVR). More particularly, the invention provides a framework for operating an IVR system using natural language programming with a customer call flow determined by rules-based functions.

2. Description of the Related Art

Presently, Voice Response hardware, such as IVRs widely used in telephone systems, is used in business applications as a way of providing a service to a customer, such as an automate customer service agent. The service can be provided to the customer automatically and without the need for the presence of a business agent, such as a telephone operator. An IVR usually plays a series of pre-recorded messages for the purposes of prompting a customer for a response and then performs a function based on the customer response. Typically, the customer responds to options that are listed by the IVR, either by pressing an appropriate button on the telephone or by speaking a verbal command into the telephone. In the process, the IVR simulates a limited conversation between a customer and an agent.

At the program level, an IVR flows from one program “state” to another according to the response of the customer. A state could refer, for example, to a point in the program where the IVR greets the customer, or a point in the program where the IVR offers a service. Different states generally provide a different list of prompts to the customer. Since an IVR provides state-dependent options, the flow of the customer through the program is well-defined depending on the customer input and the present state of the program. The resulting conversation generally is regimented and lacks the conversational qualities found in human interactions. In general, the type of programming used in providing an IVR is referred to as state-based programming, in which the flow of a program from one state to another is pre-defined and inflexible. There is a need for more flexibility in IVR conversations.

Typically, at any given state in the IVR program, the customer is provided with a list of options, in the way of words or phrases. The customer selection from the list of options is recorded by the IVR. When the customer states an option vocally, a speech recognition device matches the spoken word with a computer variable. The computer variable can be used to evaluate a machine instruction function, thereby leading to the next program state.

Another form of programming, known as natural language programming, responds to customer voice response at a language level. Customer responses can give rise to a response selected from a word database without conversion of a customer response into a machine variable. A natural language program can operate using rules of grammar and semantics, thereby bringing more conversational flexibility to an interaction. Since an IVR responds to voice stimuli, natural language programming could be directly applicable to IVRs.

### SUMMARY OF THE INVENTION

The present invention provides a system and method for providing an Interactive Voice Recognition (IVR) system for responding to a user over a data network, such as a Voice over Internet Protocol (VoIP) network. A set of rules are provided for implementing IVR functions or services. The IVR system is provided by evaluating the IVR function using natural language input based on a rules-based programming design. The IVR function provides an enterprise service. The rule is an eligibility rule for providing a service such as a presentation rule or a business rule. The business rule represents real-world business rules. The presentation rule comprises an eligibility of a customer to receive a service. The system and method evaluate the IVR function by selecting a natural language text from a vocabulary database for interaction with a customer. The system and method of the present invention present invention provides a framework, referred to as a System Management Framework (SMF), for providing a service to a customer via a voice response hardware system, such as an IVR. The IVR operates using a set of programming rules. Evaluating the rules cause transitions to be made between program states. The IVR interacts with a customer using a natural language interface with a customer. Natural language requirements are mapped into expressions. Rules evaluation operates using the natural language expressions. Upon evaluation, the program changes state according to evaluation rules. An appropriate response is selected by the output of a rules evaluation function.

Examples of certain features of the invention have been summarized here rather broadly in order that the detailed description thereof that follows may be better understood and in order that the contributions they represent to the art may be appreciated. There are, of course, additional features of the invention that will be described hereinafter and which will form the subject of the claims appended hereto.

### BRIEF DESCRIPTION OF THE DRAWINGS

For a detailed understanding of the present invention, references should be made to the following detailed description of an exemplary embodiment, taken in conjunction with the accompanying drawings, in which like elements have been given like numerals.

FIG. 1 illustrates a hardware design of an acceptable framework for implementing an embodiment of the present invention;

FIG. 2 illustrates a class structure template of a service in an embodiment of the present invention;

FIG. 3 illustrates an interface for creating a service as would be seen by a service creator in an embodiment of the present invention;

FIG. 4 illustrates state-based programming flow and rules-based programming flow in an embodiment of the present invention;

FIG. 5 shows a flowchart of an implementation of the invention using rules-based evaluation of natural language expressions in an embodiment of the present invention;

FIG. 6 illustrates a graphical a service flow using rules-based evaluations as implemented in the present invention in an embodiment of the present invention;

FIG. 7 illustrates a general flowchart of the process of creating services via the present invention in an embodiment of the present invention; and

FIGS. 8 and 9 illustrate a detailed version of the flowchart of FIG. 7 in an embodiment of the present invention.

### DETAILED DESCRIPTION OF THE INVENTION

In view of the above, the present invention through one or more of its various aspects and/or embodiments is presented to provide one or more advantages, such as those noted below.

The system and method of the present invention provides a framework, referred to as a System Management Framework (SMF), for providing a service to a customer via a voice response hardware system, such as an Interactive Voice Recognition system (IVR). The IVR interacts with a customer using a natural language interface with a customer. The IVR responds to natural language input of the customer by transitioning to a program state according to a set of program rules. The program rules are evaluated and program flow is determined using rules-based programming design.

A service in the context of the present invention is a software object representation of a real world service, such as a pizza delivery service, or a ticket purchasing service, etc. Each service has an enterprise name, which can be the name of the business organization or business enterprise client for which the service is created.

A service comprises one or more tasks that can be performed on behalf of the customer. Alternatively, a service can comprise a collection of other services that can be offered to the customer. For example, a BillPay service might offer one task, such as bill payment. A TowAndRepair service may perform multiple tasks. An ATMService might offer several services, such as BillPay or Deposit, etc. A dependent service is a service that is to be performed before another service is performed. For example, an instance of a CarWash service may depend on a BillPay service being performed first. In other words, CarWash depends on BillPay, or BillPay is a dependent service of CarWash. Services are usually offered to a customer when some specified rules related to real world conditions are met. These conditions constitute an eligibility rule of the service. For example, if a CarWash service is offered only after a CreditCard validation service is successfully performed, then an eligibility rule of CarWash could be that CreditCard validation returns a valid number. An Offering Service is a service that offers another service. For example, a GasVending service at a gas station may offer a CarWash service to a customer along with the service of purchasing gas, making the GasVending service an Offering Service for CarWash service. Generally, a service is offered to the customer when eligibility is met by the Offering Service. When CarWash is offered by GasVendingService at a gas station, CarWash becomes the Offered Service. When an Offered Service is selected by a user, and if the service is performed for the user, this process is called Performing a Service. If the customer of GasVending Service selects CarWash service, then a service is performed wherein monies for CarWash are deducted from the CreditCard account.

An eligibility clause is a group of conditions that define one business requirement. An eligibility clause can contain one or more eligibility rules. Often, an eligibility clause might evaluate to TRUE only when all eligibility conditions in the clause evaluate to TRUE. A service is offered when the eligibility rules evaluates to TRUE. Eligibility rules tend to vary according to client policy, regional differences, language differences, caller history, or special rules specified by the business enterprise. Eligibility rules can pertain to either the customer or to the business enterprise. A business enterprise condition might be the hours of operation of a service, i.e. from 9 AM to 5 PM. Service eligibility would occur between the hours of 9 AM and 5 PM. A customer eligibility rule could be that the customer has to pay all bills before the service is offered.

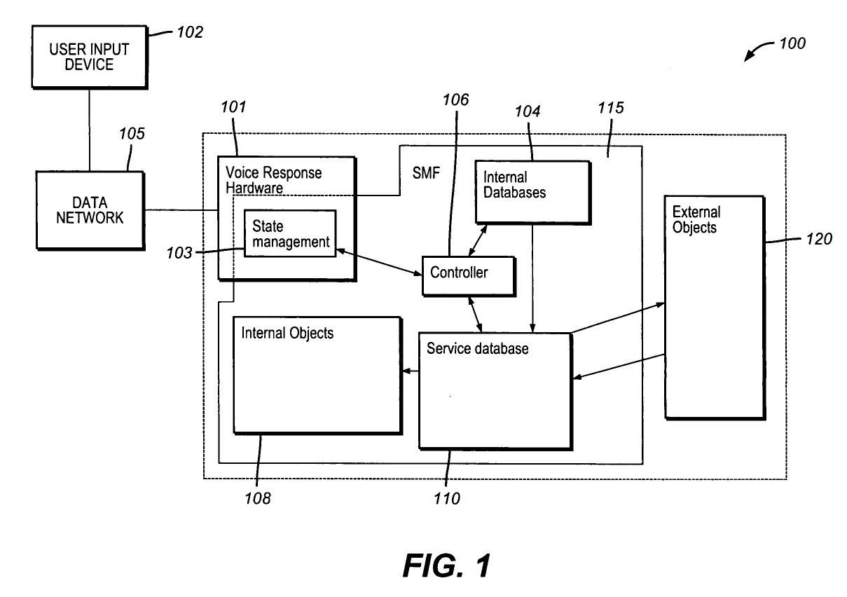

FIG. 1 illustrates a conceptual architectural design 100 of an acceptable System Management Framework (SMF) 115 for implementing an embodiment of the present invention. The SMF 115 generally stores information about what services are offered, other services on which the present service depends, whether and how a service can be performed. The framework also stores rules for action if something goes wrong while performing a service and eligibility criteria for services. SMF 115 comprises a controller 106 coupled to a service database 110, internal databases 104, and a state management device 103. The controller 106 maintains synchronized interaction between user at the Voice Response hardware 101 and service at the Services database 110. The state management device 103 is integrated into voice response hardware 101, such as an IVR, and is a counterpart on the voice response hardware 101 that interacts with the controller 106 to manage program states. The Voice Response Hardware 101 provides a voice response interface with customers. The Voice Response Hardware supports speech-based interface, DTMF interface, and a TTS (text to speech) interface. A user device 102 communicates with the Voice Response Hardware 101 via a data network 105, such as a Voice over Internet Protocol (VoIP) network. SMF services can support a speech recognition voice response hardware system as well as standard DTMF (dual tone multi-frequency) response based systems applicable for push-button telephone tones. Information pertaining to speech grammars is stored in a database to support voice response based systems.

Internal Objects 108 store objects that are used mainly in IVR systems (such as Customers, Interface Records, Offices, Agents, RoutingTNs, etc.). A new object is created in Internal Objects when a designer decides that existing objects cannot perform a desired operation. Applications or services use these Internal objects in an embodiment of the invention. Service database 110 binds internal objects 108 and external objects 120 to construct services for user interaction. An external object database 120 comprises external objects that are used by SMF 115 yet belong to other systems, such as a credit card processing interface. External objects can be accessed using DCOM (Distributed Component Object Model), RMI (Remote Method Invocation), and SOAP (Simple Object Access Protocol) (which uses lightweight XML to transmit data between different applications). A customer accesses services from the Service database 110 through the Voice Response Hardware 101, State Management device 103, and Controller 106. Internal databases 104 stores data that is best suited for storage and access from a database, such as usage metrics.

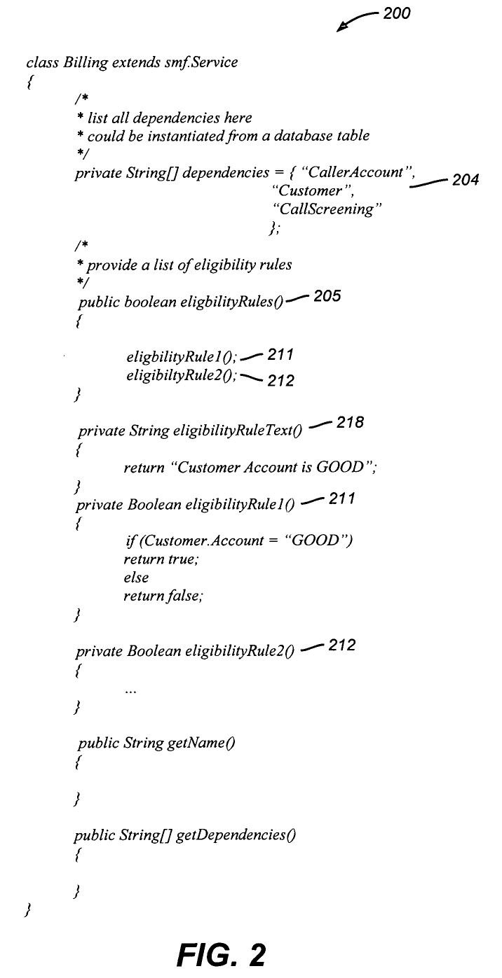

FIG. 2 illustrates a class structure programming template of a Billing service 200 that can be implemented in an embodiment of the present invention. Actual details on service creation are left as a design decision. Dependent objects 204 of the Billing service 200 are listed, such as “CallerAccount”, “Customer”, and “CallScreening”. These dependent objects are generally used in order to perform the Billing service. For instance, the Billing service may depend on obtaining a value from the CallerAccount service before a bill is paid. A set of eligibility rules 205 comprising eligibityRule1( ) 211 and eligibityRule2( ) 212 are shown. Details of eligibilityRule1( ) shows a programming code 215 for determining a value of CustomerAccount. Presentation text 218 is used when CustomerAccount evaluates favorably.

Services in the context of the present embodiment of the invention generally operate according to a set of business rules and presentation rules. A business rule is a set of conditions that businesses specify to depict the business behavior of the service. A business rule could be, for example, the hours of operation for a pizza delivery service. Business rules are generally defined by the business enterprise at creation of the service. Presentation rules determine the nature of the customer interaction. For example, if a customer has not paid previous bills, then a “harsher” voice might be used with the customer, using a different set of words. Alternately, the service may not be offered at all. Presentation rules are implemented through a presentation map

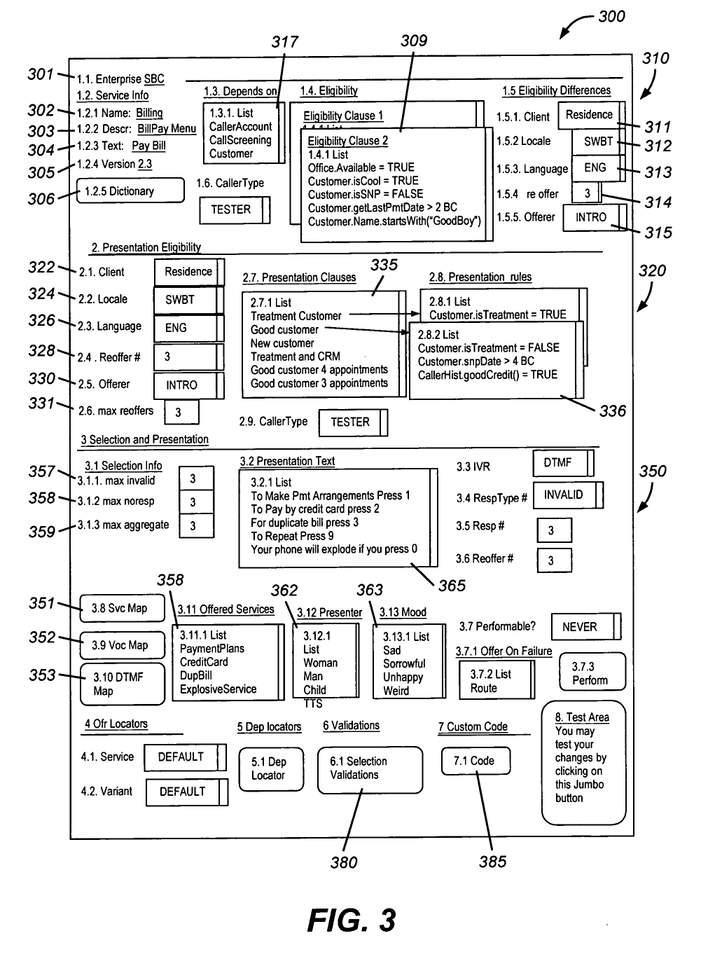

FIG. 3 illustrates an example of a graphical view of an interface 300 enabling creation of a service, as seen by a service creator, i.e. a systems analyst. The service creator inputs business conditions using a natural language code. Once accepted, the SMF translates the code into formal language rules. The interface 300 comprises, among others, an Administrative Section 310, a Presentation Eligibility Section 320, and a Selection and Presentation Section 350. The Administrative section specifies client information and eligibility rules for offering a service. The Administration Section 310 comprises an Enterprise Name 301 a Service Name 302, a Service Description 303, a Service Presentation Text 304, a Service Version 305, and a Service Semantic Dictionary 306. The Enterprise Name 301 represents the name of an organization or business enterprise with which the service is associated. Services that are created for the same business enterprise are grouped under the enterprise name. Service Name 302 indicates the function of the service. Service description 303 describes the service. Service Presentation Text 304 represents a set of text that can be spoken using TTS to a caller. A vocabulary map 352 provides a foundation of words suitable for use in presentation. Service Version 305 provides information concerning service modification. A Service Semantic Dictionary 306 provides an optional list of words that could be used to select the service (e.g., “Billing” could optional be referred to as “paying”, etc.).

The service of FIG. 3 is a Billing service. Dependencies 317 show a list of services that are either offered to customers or are instantiated before evaluating eligibility of a service for the customer.

An eligibility clause 309 is shown specifying a set of eligibility rules. Eligibility rules are related either to the business and/or to the customer. In Eligibility Clause 2 309, one eligibility clause for the office is shown (Office.Available), and four eligibility rules are shown for the customer (Customer.isCool, Customer.isSNP, Customer.getLastPmtDate, and Customer.Name.startsWith). Eligibility for a service can vary based on several factors. Eligibility variations can be based on Client 311, Region 312, Language 313, Locale 314, and Offering Service 315. A difference in eligibility for the same service is referred to as an eligibility variation. When a service behaves differently for different clients 311, a new set of eligibility clauses are provided for the variation. An eligibility variation based on region 312 may be due to logical organizational divisions by geographical area, i.e. different organizations may have different regions. Language based eligibility variations 313 take into consideration the possibility of multiple languages over a diverse speaking population. A service is generally offered to a customer more than once, up to a maximum number of offers. If a re-offered service has a different set of eligibility rules, the new set of eligibility rules can be signified as a Re-offer variation 314. Eligibility clauses 315 are specified to accommodate special eligibility requirements based on each offering service variation.

Presentation Eligibility section 320 presents customer-specific rules for offering a service to a customer. Presentation clauses 335 are eligibility clauses when applicable to presentation. Variations in presentation eligibility also vary according to client 322, locale 324, language 326, re-offer variation 328, and Offering service 330. Additionally, a maximum number of re-offers 331 of a service are specified. A list of Presentation Clauses 335 is shown, with a variety of options for presentation, i.e. for a Good Customer, and a New customer, etc. Thus, the form of the presentation depends on the caller history. A set of presentation rules 336 determine the selected presentation clause.

Selection and Presentation Section 350 governs the interface variables involved in customer interaction. The Selection and Presentation section comprises a selection of text and “behavior” of the service. Presentation Text 365 contains a list of text that can be spoken to a customer. Text is displayed in a written format in the language of the specification. Speech and IVR subsystems specify the way in which text is to be specified for Text To Speech (TTS). Selection based variation include accounting for a maximum number of invalid responses from the customer 357, a maximum number of absences of customer responses 358, and a maximum combination of invalid response and absences of response 359. When the maximum number is reached, a presentation text is provided to the customer. Offered Services 358 is a list of service names that can be offered to the customer through the Billing service. A caller can select from those services that are listed.

Presentation text can be delivered in a variety of ways. The quality of the presentation is specified using Presenter 362 and Mood 363 boxes. A choice can be made in Presenter (362) for a presenter that is a woman, a man, a child, etc. The “mood” 361 of the presenter, such as “sad”, “sorrowful”, “unhappy”, etc, can also be chosen. A vocabulary map 352 group appropriate vocabulary items so that the IVR “speaks” sensibly to the customer. Pre-recorded vocabularies can be recorded to match different moods. The text use in presentation may vary based on type of presenter of mood of the presenter. Custom code 385 can be added to the service when service processing such as eligibility and presentation cannot be achieved the set or pre-defined properties for SMF services. Selection validations 380 are provided for services that collect data from customers. Services can collect data from a variety of input, i.e. spoken input or DTMF. The data collected by the service becomes the value of the service. The value of the service changes when a service is re-offered and selected again.

Presentation Maps generally comprise service maps 351, DTMF maps 352, and vocabulary maps 353. Service maps are grammars linking spoken input from a caller to an offered service. A service map exists for every presentation variation of FIG. 3. A vocabulary item is a single unit of speech that can be spoken or replayed. For example “Welcome to Smart Car Wash,” or “Welcome.” Presentation text is logically composed of one or more vocabulary items. In general, there are two types of vocabulary items: static vocabulary items and derived vocabulary items. Static vocabulary items are defined at vocabulary creation time. A typical example of a static vocabulary item would be “Hello. How are you?” Derived vocabulary items are determined at run time and can be spoken in several different formats. An example of a derived vocabulary item would be “How are you, X?” where X can be substituted with the caller's name at runtime and can be spoken. Applications speak to callers by re-playing pre-recorded voice segments called prompts. Voice segment recordings may be in several different formats. Prompts may not necessarily be pre-recorded. Prompts can also be text segments interpreted and spoken by a machine, such as performed by specialized TTS programs. A semantically correct service offering may contain one or more prompts played in a sequence.

A vocabulary map 352 group pre-recorded vocabularies, derived vocabulary items and TTS vocabulary items together to create a sensible spoken utterance. For example, to say “Welcome to ABC. How are you?”, pre-recorded vocabulary items for “Welcome to”, derived organization vocabulary item Service.getOrganization( ) and pre-recorded vocabulary item for “How are you?” are grouped together. A vocabulary map is specified for every present text variation. Vocabulary items in the vocabulary map are re-played in an order specified by the vocabulary map.

In the present invention, the flow of a customer call is determined according to a rules-based programming system. Transition between states is performed by evaluating a set of natural language rules statements. The program transitions to the new state based on the evaluation of the rule, and the program transitions are independent of the present state of the call. Thus, a customer can move to any alternate state independent of the current state.

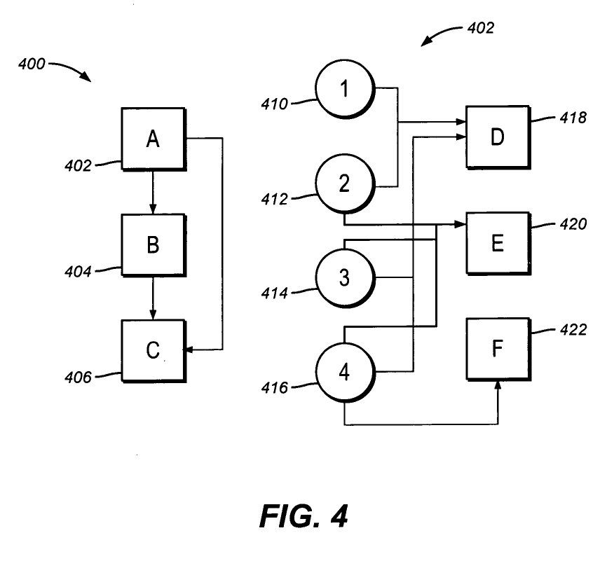

FIG. 4 illustrates state-based programming flow 400 and rules-based programming flow 402. In state-based programming flow 400, the state that the program goes to subsequent to the customer response depends on the present state of the program. As an example, one can consider a program having three states: A 404, B 406, and C 408. If the user is state A, then according to the flow diagram 400, the program will transition to either state B or state C. If the program is in state B, the program will transition into state C. If the program is in state B, the program cannot transition to state A, because the flow direction is to state C. In the context of a state-based IVR, a customer who is at one point of a transaction must complete the transaction before moving on to another task. A customer who wishes to return to state A from state B generally will have to break out of the program and begin again.

In contrast, rules-based programming enables moving transitioning one state to another regardless of the present state of the program. Rather, a set of “rules” is evaluated to determine the next state. A processor evaluates the rules and moves to the applicable state. The rules-based example 402 of FIG. 4 considers a program having three states (D 418, E 420, and F 422) and four rules (1 410, 2 412, 3 414, and 4 416). The rules might be as follows: if rule 1 and rule 2 are true, transition to state D; if rule 3 and rule 4 are true, transition to state D; if rule 1, rule 2, and rule 3 are true, transition to state E; and if rule 4 is true, transition to state F. This is shown in the diagram of FIG. 4. Thus, the transition from state to state is independent of the present state of the program. Regardless of the current state of the system (e.g., D, E, or F), the program can go to any other state. This provides a more flexible framework for an IVR interaction with a customer. Also, the customer can go through a potentially infinite number of transitions.

As another aspect of the present invention, a natural language programming format is used. Interaction with a customer is performed via a natural language front end, (i.e., the IVR). An utterance is made by the customer in response to an audio prompt at the IVR interface. These utterances are parsed using a suitable word parser. Several techniques are commonly used for practical natural language processing system. For example, finite state machines that recognize word sequences as syntactically valid sentences are often called Augmented Transition Networks (ATNs). These state machines are often written in common programming languages, such as Prolog, LISP, or C. These natural language processing systems recognize word sequences as specific words, noun phrases, verb phrases, etc. A simple example of a list of ATN patterns is shown below:

Int [] ALL_S[] = {

{NP, VP, NP, PP, VP},
{NP, VP, PP, VP},
{NP, VP, NP},
{VP, NP, PP, NP},
{VP, PP, NP},
{NP, VP},
{VP, PP},
{VP, NP},
{VP}
};

Where NP is a Noun Phrase, VP is a Verb Phrase, and PP is a Prepositional Phrase. As an example, the sentence “A dog ran” would be parseable as {NP, VP}. A program or subroutine, e.g., “ALL_S” runs through each parse pattern until it finds a suitable match. Thus the subroutine would return a value associated with {NP, VP} if “A dog ran” were given as input.

Parsed words and phrase serve as input to a function. Output of the function is also a word of phrase taken from a vocabulary database. Thus the transaction can be completed at the front end in a natural language. The parsed spoken utterance of the customer provides input into evaluation of a rule. The rule evaluation determines a selection of text to be returned to the customer. Text is selected according to presentation maps.

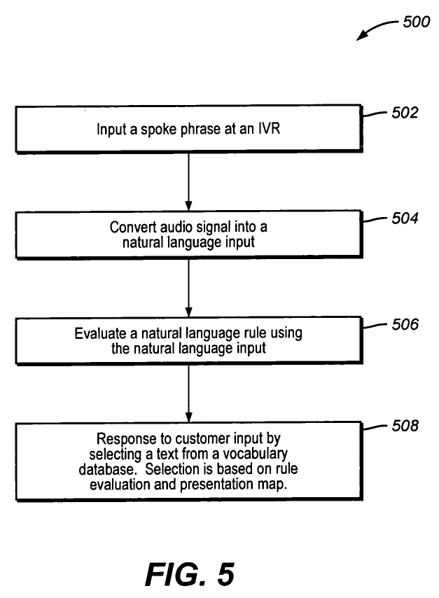

FIG. 5 shows a flowchart of an implementation of an embodiment of the present invention. A customer speaks into an IVR device 502. The input is converted to a natural language code at the IVR device generally using a parsing program 504. The natural language input service as input into a rule, such as an eligibility rule, for evaluation 506. The input from the customer could be the evaluated alone, or more likely, the rule is evaluated with other natural language rules. Evaluation of the eligibility rule sends the program into a program state. If a response is to be provided to the speaker's input, text is selected from a vocabulary database using a vocabulary map. Text is presented in a style of the Presenter and a Mood 508. A natural language synthesizer is generally provided for presentation. Presentation text can be system generated or explicitly provided in the service definition.

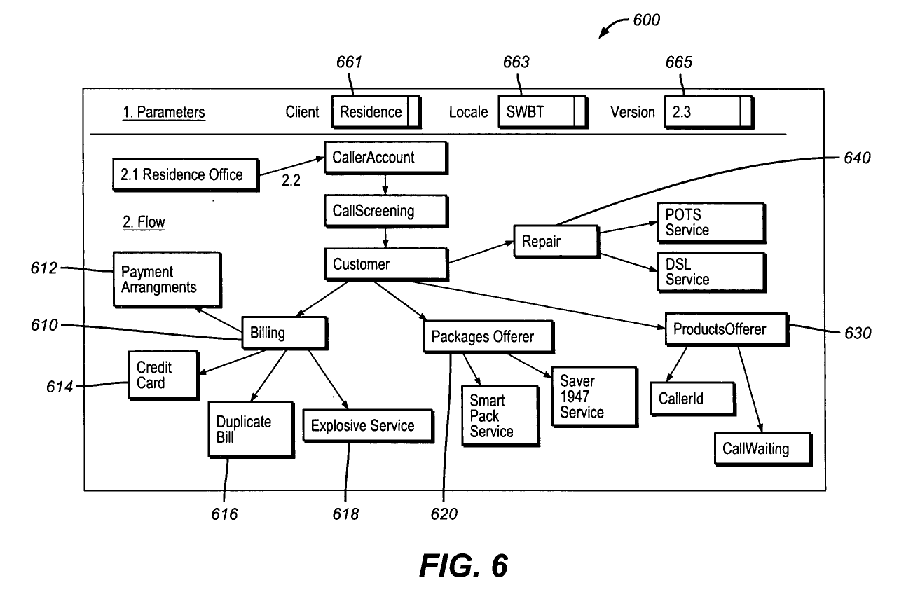

FIG. 6 illustrates a graphical representation of a service flow 600 in an example illustrating an embodiment of the present invention. Variation parameters are shown for Client 661, Locale 663, and Service Version 665. In the flow sequence, boxes represent services, and arrows represent eligibility rules. State transitions are shown flowing from a ResidenceOffice 601, a CallerAccount 603, and a CallScreening 604, to reach a Customer service 605. At the Customer state 605, services for Billing 610, Packages Offerer 620, Products Offerer 630, and Repair 640 can be offered. Each of these services may or may not be presented to the customer based on the eligibility rules of the customer. Billing service has dependent services Payment Arrangement 612, Credit Card 614, Duplicate Bill 616, and Explosive Service 618 as is shown by the connecting arrows.

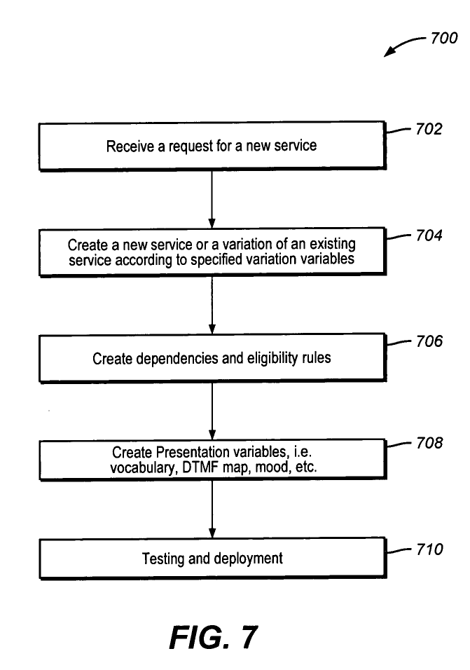

FIG. 7 illustrates a flowchart 700 of one aspect of creating of services for use in the SMF in an embodiment of the present invention. Box 702 represents a business client requesting a service to be created by the service creator. A service might be newly created or be created as a variation to a pre-existing service. In Box 704, the service is created using either a new or varied service with language and region specific variations. In Box 706, related business objects are created and eligibility requirements and dependencies are specified. Presentation variables are added to the service in Box 708. Presentation variables include, among others, a vocabulary set, a DTMF map, etc. Once the service has been created, the service is tested and deployed (Box 710).

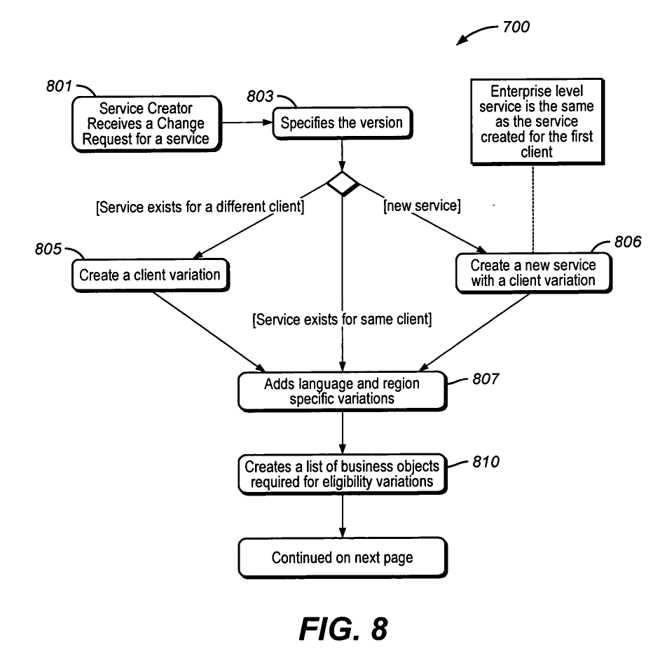

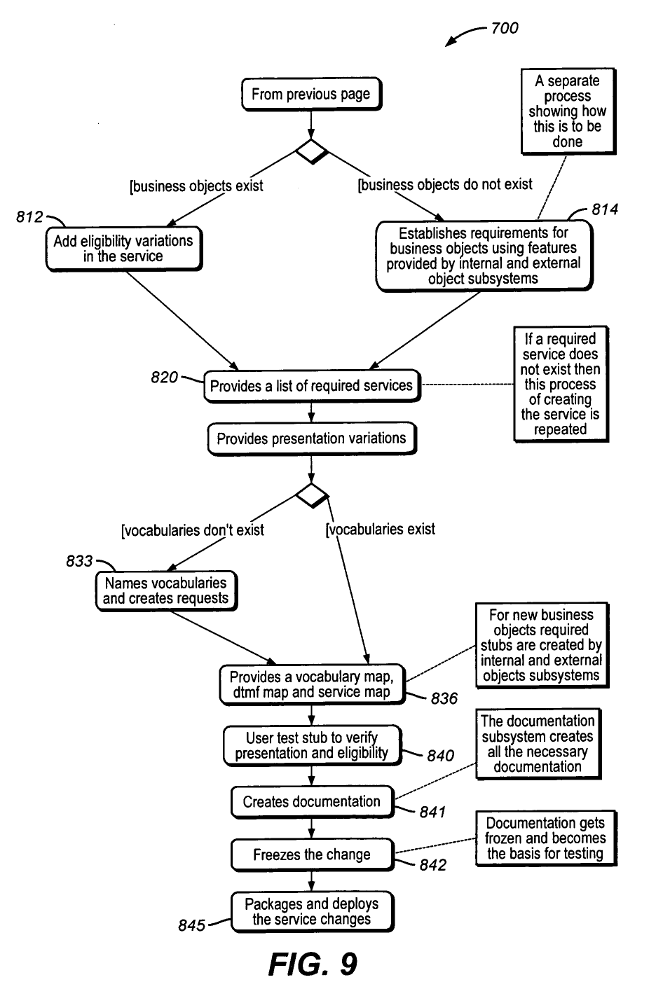

FIGS. 8 and 9 illustrates the flowchart 700 of FIG. 7 in more detail. In Box 801, a service creator, i.e. a systems analyst, receives a Change Request from a client, or a business enterprise. The request may be for specifying a version of a service to be created 803. The service may already exist for the client involved, or the service may already exist, but for a different client. If the service exists for a different client, the service creator may create a client variation of the original service 805. Otherwise, a new service can be created according to the client variation 806. Alternatively, an existing service for the same client can be used with variations. Any variations in language or in region may be added 807.

In Box 810 a list of business objects are specified to provide the appropriate eligibility variations. A business object provides access to data or business logic. A business object could be, for example, a billing database, payment/credit card business object, or an order availability business object. Business objects are generally offered to a customer according to the set of business rules laid down by the business enterprise. If appropriate business objects do not exist, then they are created here. Turning now to FIG. 9, if a business object already exists for the client 812, then a variation of the business object can usually be created. Due to similarities between variations, any change of rules often can be made for the new business object relatively quickly. If a business object does not already exist 814, then the service creator can creates the new business object. In Box 820 a list of services is provided. The listed services are those services that are used for the evaluated of the business objects, i.e. a billing address service or a phone number service can be used for providing a billing object.

In Box 830, presentation variations (present type, mood, etc.) are provided to the service. Presentation variation generally implies use of a different set of vocabulary. Thus, a variety of vocabulary maps are generally provided. If these vocabularies maps do not exist, the service can create them 833. Once the vocabulary maps are satisfactorily located or created, the vocabulary map (as well as a DTMF map and a service map) is provided 836. So the system checks to see if the vocabulary for provided the proper presentation exists or not. If the vocabulary does not exist, then the vocabulary map is provided so that the service can be performed. The service map is able to determine from speech-recognition based natural language recognition if the keyword is present and recognizable from the customer phrase.

A system analyst can then test the service to verify presentation rules and eligibility rules 840. Once verification is complete, documentation is added to the service 841 and changes are set in place 842. The service is then packaged and deployed 845 to provide an IVR system implementing the business, eligibility and presentation rules.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods, and uses such as are within the scope of the appended claims.

In accordance with various embodiments of the present invention, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the present invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to e-mail or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

What is claimed is:

1. A method for providing an Interactive Voice Recognition (IVR) system, comprising:
a) defining at least one rule for implementing at least one IVR function; and
b) providing an IVR system by evaluating the at least one IVR function using natural language input from a data network.

2. The method of claim 1, wherein at least one rule is a rule according to a rules-based programming design.

3. The method of claim 1, wherein the at least one IVR function provides an enterprise service.

4. The method of claim 1, wherein the at least one rule is an eligibility rule for providing a service.

5. The method of claim 4, wherein the eligibility rule is one from a list of i) a presentation rule, or, ii) a business rule.

6. The method of claim 5, wherein the business rule further comprises a rule representing real-world business rules.

7. The method of claim 5, wherein the presentation rule further comprises an eligibility of a customer to receive a service.

8. The method of claim 1, wherein evaluating the at least one IVR function further comprises selecting a natural language text from a vocabulary database for interaction with a customer.

9. The method of claim 1, wherein the data network is a Voice over Internet Protocol network.

10. A computer readable medium containing instructions that when executed by a computer perform a method for providing an Interactive Voice Recognition (IVR) system, comprising:
a) defining at least one rule for implementing at least one IVR function; and
b) providing an IVR system by evaluating the at least one IVR function using natural language input from a data network.

11. The medium of claim 10, wherein in the method at least one rule is a rule according to a rules-based programming design.

12. The medium of claim 10, wherein in the method the at least one IVR function provides an enterprise service.

13. The medium of claim 10, wherein in the method the at least one rule is an eligibility rule for providing a service.

14. The medium of claim 13, wherein in the method the eligibility rule is one from a list of i) a presentation rule, or, ii) a business rule.

15. The medium of claim 14, wherein in the method the business rule further comprises a rule representing real-world business rules.

16. The medium of claim 14, wherein in the method the presentation rule further comprises an eligibility of a customer to receive a service.

17. The medium of claim 10, wherein in the method evaluating the at least one IVR function further comprises selecting a natural language text from a vocabulary database for interaction with a customer.

18. The medium of claim 10, wherein in the method the data network is a Voice Over Internet Protocol network.

19. A system for providing an Interactive Voice Recognition (IVR) system, comprising:
a) a data network providing a data connection between the IVR and a user;
b) a database containing at least one rule for implementing at least one IVR function; and
c) a processor that evaluates the at least one IVR function using natural language input from the user to provide an IVR system.

20. The system of claim 19, wherein at least one rule is a rule according to a rules-based programming design.

21. The system of claim 19, wherein the at least one IVR function provides an enterprise service.

22. The system of claim 19, wherein the at least one rule is an eligibility rule for providing a service.

23. The system of claim 21, wherein the eligibility rule is one from a list of i) a presentation rule, or, ii) a business rule.

24. The system of claim 23, wherein the business rule further comprises a rule representing real-world business rules.

25. The system of claim 23, wherein the presentation rule further comprises an eligibility of a customer to receive a service.

26. The system of claim 19, wherein the processor evaluates the at least one IVR function by selecting a natural language text from a vocabulary database for interaction with a customer.

27. The system of claim 19, wherein the data network is a Voice Over Internet Protocol data network.
